(19) United States
(12) Patent Application Publication
(10) Pub. No.: US 2015/0127451 A1
(43) Pub. Date: May 7, 2015

(54) SYSTEM AND METHOD FOR CONTROLLING AD IMPRESSION VIOLATIONS

(71) Applicants: F. Scott Yeager, LIano, TX (US); David Cox, Destin, FL (US); Will Grannis, Destin, FL (US)

(72) Inventors: F. Scott Yeager, LIano, TX (US); David Cox, Destin, FL (US); Will Grannis, Destin, FL (US)

(21) Appl. No.: 14/529,691

(22) Filed: Oct. 31, 2014

Related U.S. Application Data
(60) Provisional application No. 61/898,398, filed on Oct. 31, 2013.

(51) Int. Cl. G06Q 30/02

(52) U.S. Cl. CPC G06Q 30/0248
USPC 705/14.47

(57) ABSTRACT

A method of controlling ads includes receiving a beacon over a network identifying an ad, an end user and a content source; querying a database of unauthorized content sources based on the beacon; determining whether the ad is an unauthorized impression; and storing information from the beacon in a database, including whether the impression was authorized or unauthorized. The database may include a list of unauthorized sites and the querying may include checking whether the content source is one of the unauthorized sites. Querying also may be used by advertising exchanges and networks to determine whether to place an ad on a particular publisher's site.

### FIELD OF THE INVENTION

The invention relates generally to ads and ad delivery over networks and, more particularly, to monitoring and controlling the delivery of ad impressions and determining whether ad impressions violate advertising policies.

### BACKGROUND OF THE INVENTION

The delivery of advertising over the Internet to end users has become widespread. There are many market participants involved in the process, including advertisers and advertising agencies and networks and advertising exchanges which help advertisers place advertisements on the screens of end users as the users visit various sites on the internet which designate portions of their webpages for delivering advertisements.

In general, existing processes excel at identifying advertising space available on various websites as user devices interact with these websites and webpages. However, there are challenges associated with measuring the real performance of advertising delivery as there can be waste or abuse in the process in the form of an ad being delivered via websites to non-existent users. Another significant problem is the delivery of advertising via websites that carry illicit content or undesirable content for particular advertisers. In a system designed to maximize delivery of ad impressions on every bit of available space, the system excels at ad delivery, but not at preventing delivery of impressions where they should not be delivered and not at preventing other types of ad delivery abuses that overstate actual impressions delivered to unique users.

With respect to limiting provision of ads to websites that provide illicit content or that otherwise provide content that advertisers want to avoid being associated with, there are many problems that have limited the effectiveness of advertising systems to date. One problem is that the Internet is dynamic and new sites are constantly popping up that may have undesirable characteristics. Another problem is that it can be difficult to publish and get consensus as to what is an illicit website among any group of advertisers because there may be unintended backlashes from such an effort.

Accordingly, there remains a need for a system and method to monitor and control ad impressions that interacts with advertisers and other market participants in the advertising process that facilitates making neutral, unbiased decisions with respect to acceptable and unacceptable websites. There is a further need for such as system to be able to identify in real time the delivery of ad impressions to unauthorized sites and to facilitate advertisers controlling ad campaign delivery.

### SUMMARY OF THE INVENTION

According to the present invention, a neutral entity maintains a list of content providers or publishers on the Internet (such as websites) that are on an excluded list because they operate illicit sites according to some criteria. There may be more than one list and each list may reflect ratings for the list of sites embodied in the list. In addition, advertisers, advertising agencies, advertising exchanges and other players who place ads may register with the advertising compliance authority server. By doing so, the advertiser agrees to a policy with respect to what which websites are to be excluded or included in the ad campaign. The advertiser also agrees to allowing a beacon to be associated with its advertising content to be delivered along with the ads. The beacon includes address information for the advertising compliance server as well as code, such as java script code which is triggered when the ad impression is placed on the user's computer. The java script sends back to the ACA certain information that allows the ACA to determine whether the add was authorized according to the advertiser policy or was an impression violation. This information may include information about the end user, the publisher, the time and location of the impression and other information.

In this manner, the ACA allows a list of unauthorized sites to be maintained in a neutral, confidential and objective manner and allows advertisers to rely on this resource to take steps to ensure that ads are not delivered to users via publishers that are unauthorized. Additionally, the system allows instances of authorized impressions to be identified in each instance and then later used in a compliance or audit process.

Advertisers may direct the ACA to enforce advertiser policies that dictate on what domains and what Network End Nodes (Person(s)) their advertisements can and/or cannot be presented to). In this regard, the ACA itself will maintain exclusion lists that will remain confidential and will apply neutral and objective criteria. There may be more than one exclusion list. At the same time, the ACA may allow publishers and content providers to certify themselves and therefor place themselves on various inclusion lists, which might have certain attributes that are associated with a particular advertiser's policies or at a minimum allow the publisher to stay off of one or more exclusion lists that also may be associated with an advertiser policies.

The ACA will be a mechanism to prevent advertisements from appearing on Domains and Network End Nodes that are indicated by ACA to Advertising Networks and Advertising Exchanges as unauthorized. The Advertisers may also indicate to ACA what Domains and Network End Nodes their advertisements can and/or cannot be presented on and direct the ACA to accumulate a known threat list that will include Domains and Network End Nodes. The ACA may then determine, with no direct oversight by the Advertiser, on what Domains and Network End Nodes their advertisements can and/or cannot be presented on according to the ACA's criteria.

Additionally, for monitoring and compliance, the advertiser may place an ACA tracking beacon inside their Advertisements that will determine, among other things, the domain and network end node that the advertisements are presented on and will ascertain by querying the ACA threat list in real-time, if impression violations are made by either a participating advertising network or an advertising exchange. Advertisers will have the ability to terminate domains, network end nodes, advertising networks and advertising exchanges from presenting their advertisements in real-time via a GUI provided by the ACA.

According to one embodiment of the invention, a method of controlling ads includes receiving a beacon over a network identifying an ad, an end user and a content source; querying a database of unauthorized content sources based on the beacon; determining whether the ad is an unauthorized impression; and storing information from the beacon in a database, including whether the impression was authorized or unauthorized. The database may include a list of unauthorized sites and the querying may include checking whether the content source is one of the unauthorized sites. Additionally, the database may include multiple lists of unauthorized sites and the querying may include checking whether the content source is on at least one of the lists of unauthorized sites depending on an advertisement policy.

According to another embodiment of the invention, a system for controlling ads includes a memory, a compliance server and a database of unauthorized content sources. The memory includes a program for determining whether ad impressions are authorized. The server executes the program causing the server to receive beacons from ad impressions at user computers; extract ad, end user and content source information; query the database of unauthorized content sources based on the extracted information; determine whether the ad is an unauthorized impression; and store information from the beacon in a database, including whether the impression was authorized or unauthorized. The beacon information may be presented to registered users in real time for monitoring or may be used later for compliance auditing.

### BRIEF DESCRIPTION OF THE FIGURES

The above described advantages of the invention will be more fully appreciated with reference to the appended Figures.

FIG. 1 depicts a system for providing monitoring and controlling advertisements according to one embodiment of the present invention.

FIG. 2 depicts a system for providing monitoring and controlling advertisements, showing paths of ads, content and beacons according to one embodiment of the present invention.

FIG. 3 depicts a view of the advertising compliance authority server and its relationship with networks and databases according to one embodiment of the invention.

FIG. 4 depicts a method of using the ACA to query for authorized publishers to facilitate placing authorized ads according to one embodiment of the present invention.

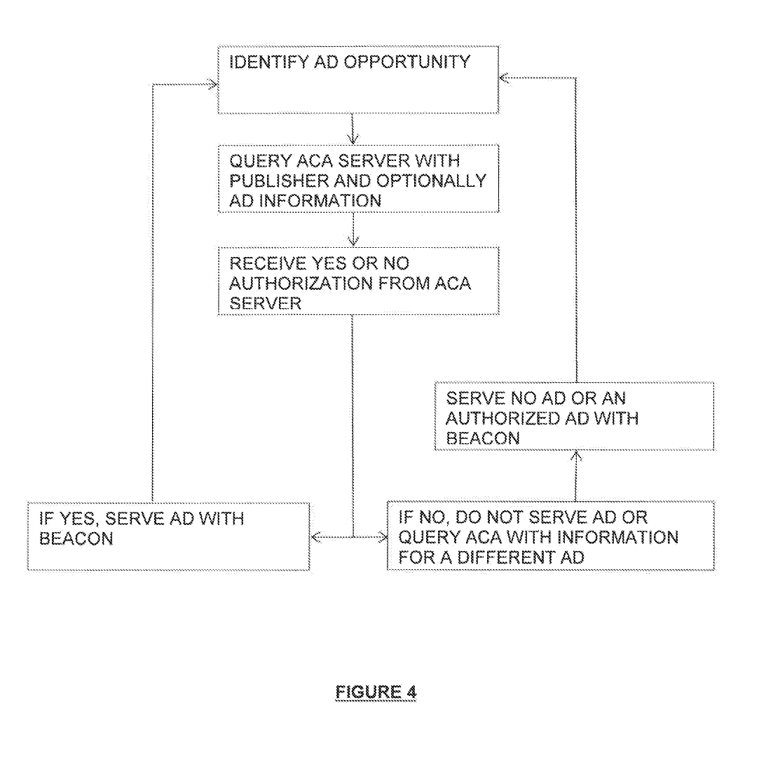

### DETAILED DESCRIPTION

According to the present invention, a neutral entity maintains a list of content providers or publishers on the Internet (such as websites) that are on an excluded list because they operate illicit sites according to some criteria. There may be more than one list and each list may reflect ratings for the list of sites embodied in the list. In addition, advertisers, advertising agencies, advertising exchanges and other players who place ads may register with the advertising compliance authority server. By doing so, the advertiser agrees to a policy with respect to what which websites are to be excluded or included in the ad campaign. The advertiser also agrees to allowing a beacon to be associated with its advertising content to be delivered along with the ads. The beacon includes address information for the advertising compliance server as well as code, such as java script code which is triggered when the ad impression is placed on the user's computer. The java script sends back to the ACA certain information that allows the ACA to determine whether the add was authorized according to the advertiser policy or was an impression violation. This information may include information about the end user, the publisher, the time and location of the impression and other information.

In this manner, the ACA allows a list of unauthorized sites to be maintained in a neutral, confidential and objective manner and allows advertisers to rely on this resource to take steps to ensure that ads are not delivered to users via publishers that are unauthorized. Additionally, the system allows instances of authorized impressions to be identified in each instance and then later used in a compliance or audit process.

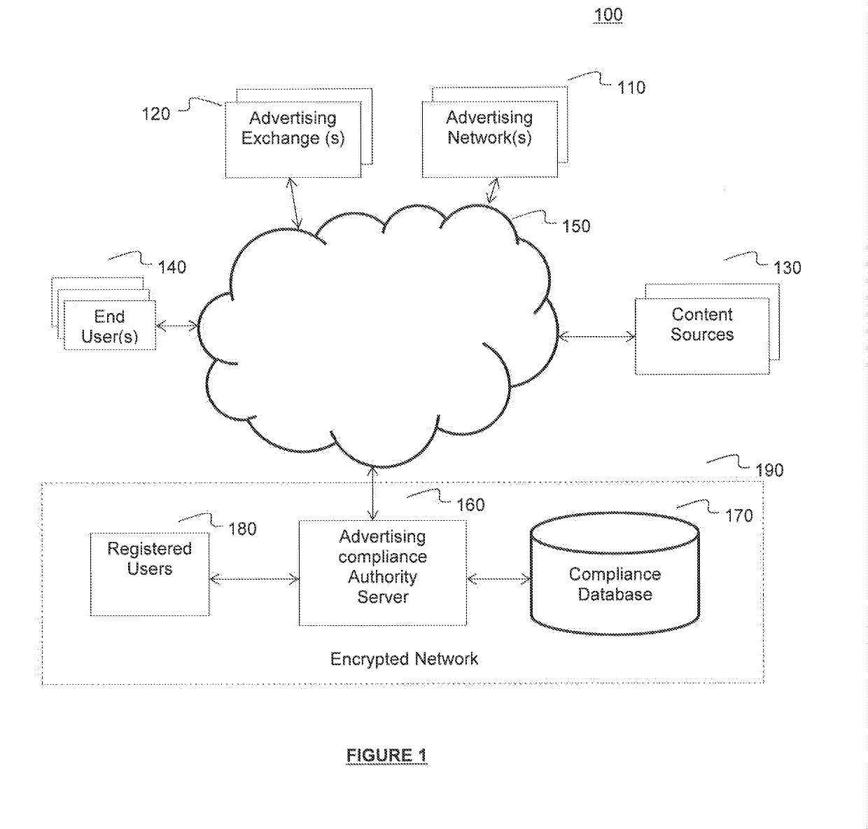

FIG. 1 depicts a system 100 for advertising compliance according to an embodiment of the invention. Referring to FIG. 1, Advertising exchanges 120, advertising networks 110, content sources 130 and end users are coupled to a network, such as the Internet 150. The advertising networks and advertising exchanges maintain an inventory of advertisements, which may be content files such as jpeg or mpeg files, together with java script program files or other files which may be served up by the content providers to end users in web pages to form advertisements that are delivered to the end users. The end users generally receive content from the content sources 130 and receives advertisements from the same content provider 130 or directly from an advertising exchange or network.

FIG. 1 further includes an advertising compliance authority server 160, a compliance database 170 and registered users 180. The advertising compliance authority (ACA) server has several roles in controlling unauthorized advertising. The ACA interacts with one or more databases which include information such as the list of unauthorized content providers or website operators, and a database of registered users, advertisers, ads and beacon information among other things. The ACA interacts with registered users, the databases and the advertising networks and advertising exchanges to allow real time ad compliance. The ACA server, registered users and compliance database may all interact with each other over an encrypted network. Similarly, while not shown in FIG. 1 directly, the ACA server may also interact with the advertising exchange servers 120 and advertising network servers 110 over an encrypted network, in each case public or private.

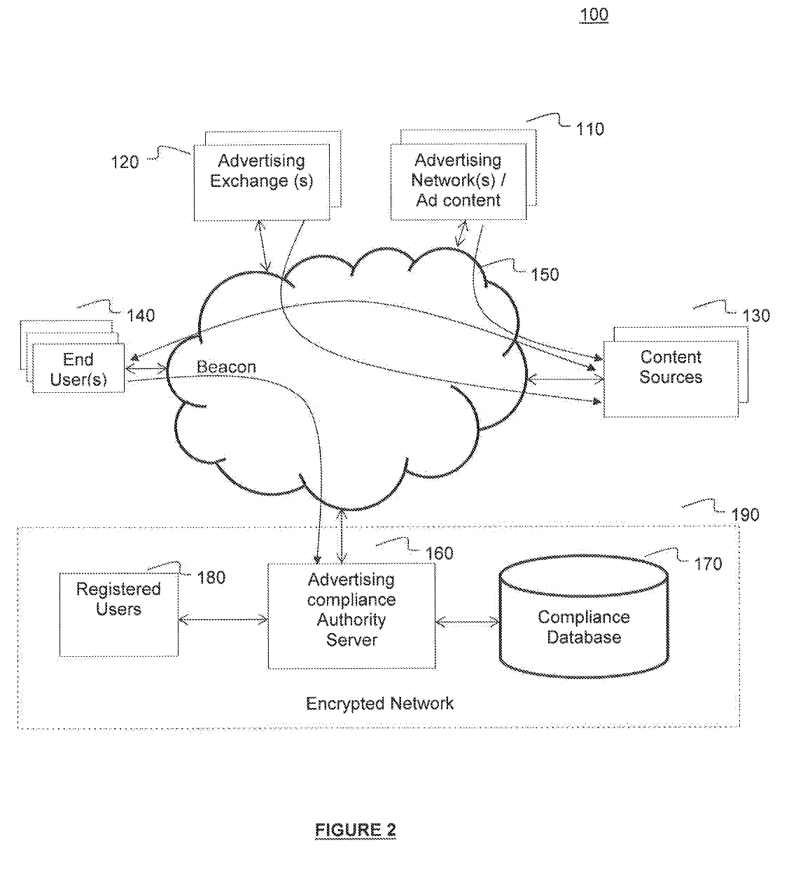

FIG. 2 depicts the advertising compliance network of FIG. 1, showing with the addition of arrows shown an illustrative ad insertion path. Referring to FIG. 2, an end user device 140 is connected to the Internet 150 with a browser, for example, and the browser issues a request from a content publisher 130 via the browser. The browser 140 responds to the request for content and provides the content to the end user with an advertisement. The advertisement comes from, for example the advertising exchange 120 or the advertising network 110 and the advertisement itself includes a beacon.

The beacon may be provided for all advertisements from particular advertisers, for certain advertisements from particular advertisers, for some or all advertisers whose ads are being placed via an exchange 120 or ad network 110 or any combination of the foregoing. In general, when the foregoing entities register with the advertising compliance authority, these parameters are worked out, allowing the beacon to be associated with the advertiser or relevant advertising exchange or network and particular registered users within these entities.

The beacon itself may be written in software, such as java script, and may run when the user's device receives an ad and runs it as part of the impression provided to the user. The beacon code causes the user's device to capture information regarding the impression and its context and send the information to the ACA server. Illustrative information collected may include IP address and port information for the user device, and the content sources and the source of the ad; cookie information; owner of ad information; ad campaign ID; host location for host that injects the ad; browser/window size; referring location (search engine or another page); domain name information for the referring domain and content source, including the web page itself within the domain. Any other convenient information may be collected by the beacon that may be useful for the ACA, such as the identify the end user, source of the ad and source of the content/page that embedded the ad and other pertinent ad information such as the owner of the ad and campaign id, and time and date of impression.

Once the ad is displayed by the user device 140, the beacon runs, collects information as described above and send a message over the Internet to the ACA server 160. The ACA 60 stores all of the beacon messages it receives in the database 170. In this manner, the ACA develops a record of the impressions of all ad impressions that are provided to users together with sufficient information for each impression to identify the user and content provider. The user and content provider information can then be used by the ACA server to determine for each advertisement whether it was authorized or unauthorized.

Additionally, the advertising exchanges 120 and advertising content networks 110 may also be registered with the ACA server 160. In this case, these entities may, prior to providing a particular ad to a particular content source or end user, send a query to the ACA with the content source or end user, optionally with additional information about the ad such as the ad number, campaign number, ad owner, or other identifying information. In response, the ACA may return yes or no information about whether or not the end user or content source is authorized for the ad owner, ad or ad campaign, for example. In this manner, the exchanges will be able to determine whether a particular ad can be served to the content source, or if not whether a different ad would be appropriate for the content source given the presence of the domain on certain exclusion lists within the database 170.

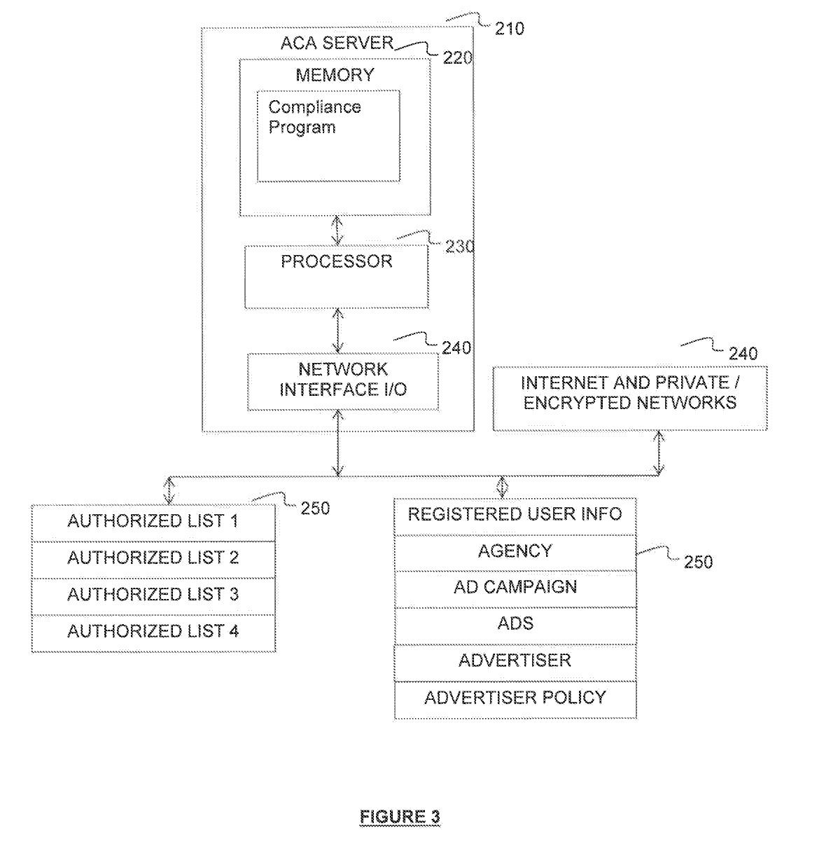

FIG. 3 depicts a view of the ACA server and its interaction with the database 170 and networks. The ACA server itself may include a memory, a processor and a network interface and i/o unit that exchange data. The memory may store the compliance program which includes program instructions executed by the processor which causes the server to execute the methods for monitoring and controlling advertisements described herein. The network interface allows the server to be coupled over the public Internet and private networks in an unencrypted or encrypted and secure method. The ACA server and its interactions with the database, registered users and the advertising exchanges and advertising networks may preferably be implemented via encrypted connections either over the public network or via a private network for enhanced security.

The database 170 may include an exclusive list of websites such as the list 250 shown in FIG. 3. This list may identify end users, publishers, websites, web pages, and other online sources of content by IP address, domain name, ports and any other useful identifying information. The database 170 also stores the beacon information. The database 170 also includes information 250 shown in FIG. 3 on registered users, ad agencies (with whom registered users are associated), ad campaigns information include owners, ad content and other ad information, advertiser information and any other information that identifies and relates ads to ad owners, registered users and other entities involved in the advertising process.

The ACA interacts with the database and allows registered users to log in and track ads and ad campaigns by reviewing beacon information as well as information stored in the database in association with the beacon, such as whether the impression reflected in each beacon was authorized or unauthorized. A variety of reporting information is also possible. For example, the beacon information may be displayed in real time on a world map to show ad impressions in real time and indicate which ones are authorized and which ones are not by projecting them on a map with different colors for authorized an unauthorized. Lists of unauthorized ads may also be generated for compliance and auditing purposes.

In general, the ACA performs the following functions: 1) Receive and store beacons in the database; 2) maintain registered user, advertiser, advertisement and advertising campaign information; 3) receive and respond to queries from advertisers, exchanges, ad networks and any other advertising parties; 4) allow publishers to certify themselves as authorized websites and therefore go on an inclusion list within database 170; 5) real time reporting (which may be organized by registered user, by advertisement owner, by agency, ad network, ad agency, by ad, by campaign, or by any other convenient metric) by serving beacon information in real time to registered users for the past day, week moth, year or any other timeframe to facilitate real time monitoring and display of authorized and/or unauthorized ad usage or historical auditing; and 6) enforcing advertising policies by responding to queries for ad placements with particular publishers or content providers and comparing the received queries with one or more exclusion or inclusion lists (for certified sites, for example) to determine whether or not the ad is authorized.

The advertisement policy may be any convenient collection of information that may be enforced by the ACA server. In general, the advertisement policy will include at least rules correlating an advertiser, an ad or an ad campaign with one or more lists of unauthorized sites or users, or one or more lists of authorized sites or users. The policy may be uniform or may vary by geographic region and/or by ad or ad campaign or target demographic, such as by age of intended recipient.

While particular embodiments have been shown and described herein, it will be understood by those having ordinary skill in the art that changes may be made to those embodiments without departing from the spirit and scope of the present invention.

What is claimed is:

1. A method of controlling ads, comprising:
receiving a beacon over a network identifying an ad, an end user and a content source identifier;
querying a database of unauthorized content sources based on the beacon;
determining whether the ad is an unauthorized impression; and
storing information from the beacon in a database, including whether the impression was authorized or unauthorized.

2. The method according to claim 1, wherein the database includes a list of unauthorized sites and the querying includes checking whether the content source is one of the unauthorized sites.

3. The method according to claim 2, wherein the list includes a plurality of lists of unauthorized sites and the querying includes checking whether the content source is on at least one of the lists of unauthorized sites.

4. The method according to claim 3, wherein the database include identifiers associating ads with at least one of the lists of unauthorized sites.

5. The method according to claim 3, wherein the database includes identifiers associating ads with users authorized to receive information about impressions and unauthorized impressions of the ads.

6. The method according to claim 5, wherein the users are registered users associated with an advertiser or an advertising agency.

7. A method of placing an ad, comprising:
determining a content provider and user for serving an ad;
querying an advertising compliance server with information for the proposed ad;
placing the ad if the advertising compliance server indicates the ad is authorized and not placing the ad if the advertising compliance server indicates the ad is not authorized.

8. A system of controlling ads, comprising:
a memory having a program for determining whether ad impressions are authorized;
a compliance server coupled to the Internet; and
a database of unauthorized content sources;
wherein the program is capable of being executed by the server and capable of causing the server to: receive beacons from ad impressions at user computers; extract ad, end user and content source information; query the database of unauthorized content sources based on the extracted information; determine whether the ad is an unauthorized impression; and store information from the beacon in a database, including whether the impression was authorized or unauthorized.

9. The system according to claim 8, wherein the database includes a list of unauthorized sites and the querying includes checking whether the content source is one of the unauthorized sites.

10. The system according to claim 9, wherein the list includes a plurality of lists of unauthorized sites and the querying includes checking whether the content source is on at least one of the lists of unauthorized sites.

11. The system according to claim 10, wherein the database include identifiers associating ads with at least one of the lists of unauthorized sites.

12. The system according to claim 8, wherein the database includes identifiers associating ads with users authorized to receive information about impressions and unauthorized impressions of the ads.

13. The system according to claim 5, wherein the users are registered users associated with an advertiser or an advertising agency.

14. A computer program product, having computer program logic stored therein, the computer program logic comprising:
receiving logic for causing a server to receive a beacon over a network identifying an ad, an end user and a content source identifier;
querying logic for causing a server to query a database of unauthorized content sources based on the beacon;
determining logic for causing a server to determine whether the ad is an unauthorized impression; and
storing logic for causing a server to store information from the beacon in a database, including whether the impression was authorized or unauthorized.

15. The computer program logic according to claim 14, wherein the database includes a list of unauthorized sites and the querying includes checking whether the content source is one of the unauthorized sites.

16. The computer program product according to claim 15, wherein the list includes a plurality of lists of unauthorized sites and the querying includes checking whether the content source is on at least one of the lists of unauthorized sites.

17. The computer program product according to claim 16, wherein the database include identifiers associating ads with at least one of the lists of unauthorized sites.

18. The computer program product according to claim 17, wherein the database includes identifiers associating ads with users authorized to receive information about impressions and unauthorized impressions of the ads.

19. The computer program product according to claim 18, wherein the users are registered users associated with an advertiser or an advertising agency.
